(19) United States
(12) Patent Application Publication
(10) Pub. No.: US 2015/0311007 A1
(43) Pub. Date: Oct. 29, 2015

(54) CIRCUIT BREAKER RESTRAINING DEVICE

(71) Applicant: Douglas Elam Albertson, Richmond, VA (US)

(72) Inventor: Douglas Elam Albertson, Richmond, VA (US)

(21) Appl. No.: 14/633,869

(22) Filed: Feb. 27, 2015

Related U.S. Application Data
(60) Provisional application No. 61/948,191, filed on Mar. 5, 2014.

(51) Int. Cl. H01H 9/02

(52) U.S. Cl. CPC H01H 9/02

(57) ABSTRACT

A circuit breaker restraining device will prevent accidental removal of a circuit breaker from a circuit breaker board or box. The device is configured to be of universal size for use in a large number of different circuit breaker boxes by a number of different manufacturers. The device is thin enough to fit between adjacent circuit breakers, of sufficient length to span the snap-in circuit board, and includes a restraining device to keep the circuit breakers in place.

### CROSS-REFERENCE TO RELATED APPLICATION

This application claims the benefit of U.S. Provisional Application No. 61/948,191, filed Mar. 5, 2014, the contents of which are incorporated herein by reference.

### FIELD OF THE INVENTION

The invention relates generally to lock out devices for circuit breakers, and more particularly breaker restraining devices to prevent the accidental disengagement of a snap-in breaker used to back feed electrical panels.

### BACKGROUND OF THE INVENTION

Many homes and businesses that receive electricity from the electrical power grid have installed local electrical generators in order to provide power in times when power from the grid has been disrupted, such as during a storm or other outage. Additionally, others have portable generators that can be used during power outages. Where power is generated locally, the National Electric Code (NEC) requires that the local circuit include a back feed breaker that is interlocked to the utility breaker to prevent locally generated electrical power from being fed back into the grid.

Back feed breakers are typically installed in the circuit breaker panel box and many available back feed breakers are of the snap-in variety. That is, the breaker is simply installed by snapping the breaker into place in the circuit box. The NEC now requires that where a snap-in back feed breaker is installed, it “shall be secured in place by an additional fastener that requires other than a pull to release the device from the mounting means on the panel.” The snap-in back feed breaker must be restrained by a device that prevents it from being removed except by an intentional pull. In other words, the restraining device must prevent the breaker from popping out of position.

Some circuit breaker panel box manufacturers have created metal or plastic restraining devices that restrains the breaker, but these devices are typically specific to that particular panel for which it was designed; it cannot be used for other circuit breaker panels. Thus, a person needing to install a restraining device must first determine if the panel box he has is designed to accept a restraining device, and if so, must obtain the specific retaining device for the panel box from the manufacturer. Retaining devices are generally not readily available because there is a plethora of different panel box models and designs. Thus, it is difficult to obtain the correct restraining device for any specific circuit breaker panel box.

Additionally, restraining devices are often not available for circuit breaker panel boxes manufactured prior to 1990 because at that time the NEC did not require restraining devices for snap in breakers. Manufacturers have generally not provided restraining devices for boxes manufactured prior to that date. In some instances manufacturers do not even provide restraining devices even for new panel box designs.

Due to the increasing number of power outages in recent years, more homeowners and businesses want an affordable and efficient method to connect a generator to their electrical circuit to provide power in the event of a power outage. Most electrical panels can accommodate a back feed breaker to accomplish the back feeding of power from a generator. However, many existing panels do not have or offer the back feed breaker retaining device that is required by the current NEC. Thus, there is a need for a universal snap in breaker restraining device that can be used with a wide range of panels.

### SUMMARY OF THE INVENTION

The invention provides various exemplary embodiments, including devices and systems that can be implemented as devices for restraining circuit breakers to prevent the unintentional removal of the back feed breaker.

These and other features and advantages of exemplary embodiments of the invention are described below with reference to the accompanying drawings.

### BRIEF DESCRIPTION OF THE DRAWINGS

FIG. 1 is a perspective view of the breaker restraining device according to the present invention.

FIG. 2 is a perspective view of the breaker restraining device as in FIG. 1 secured within a circuit breaker panel.

### DETAILED DESCRIPTION

In the following description, a number of materials are identified as suitable for various facets of the implementations. These materials are to be treated as exemplary and are not intended to limit the scope of the claims. A number of dimensions and sizes are identified as suitable for various facets of the implementations. These dimensions and sizes are to be treated as exemplary and are not intended to limit the scope of the claims.

The invention is directed to a circuit breaker restraining device that can be used to prevent a circuit breaker from becoming dislodged from the circuit breaker panel. Certain aspects of the device make it universal in nature and capable of being used with a wide variety of circuit breaker panel boxes.

The device is formed of a thin sheet of material that can easily fit between circuit breakers within a circuit breaker panel, includes a tab to restrain or prevent the accidental removal of a circuit breaker, and can be easily attached to the panel box.

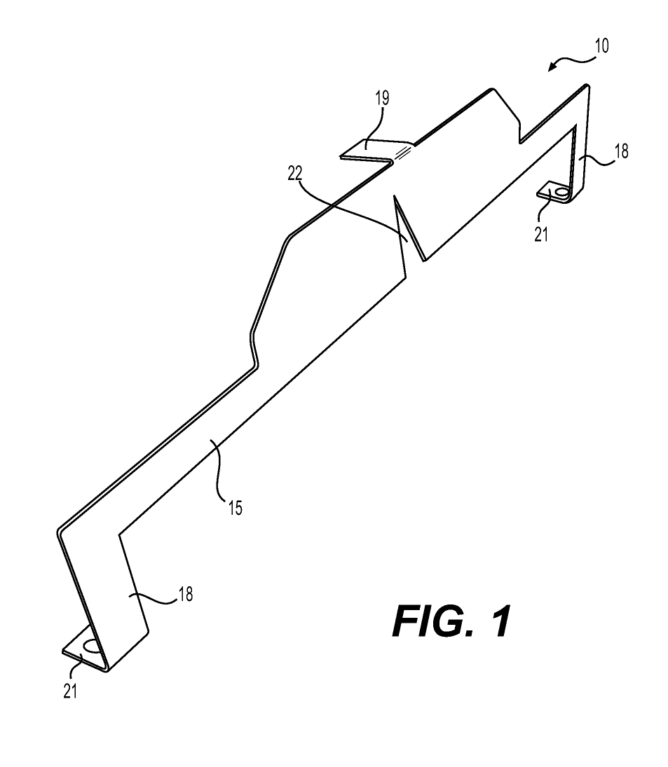

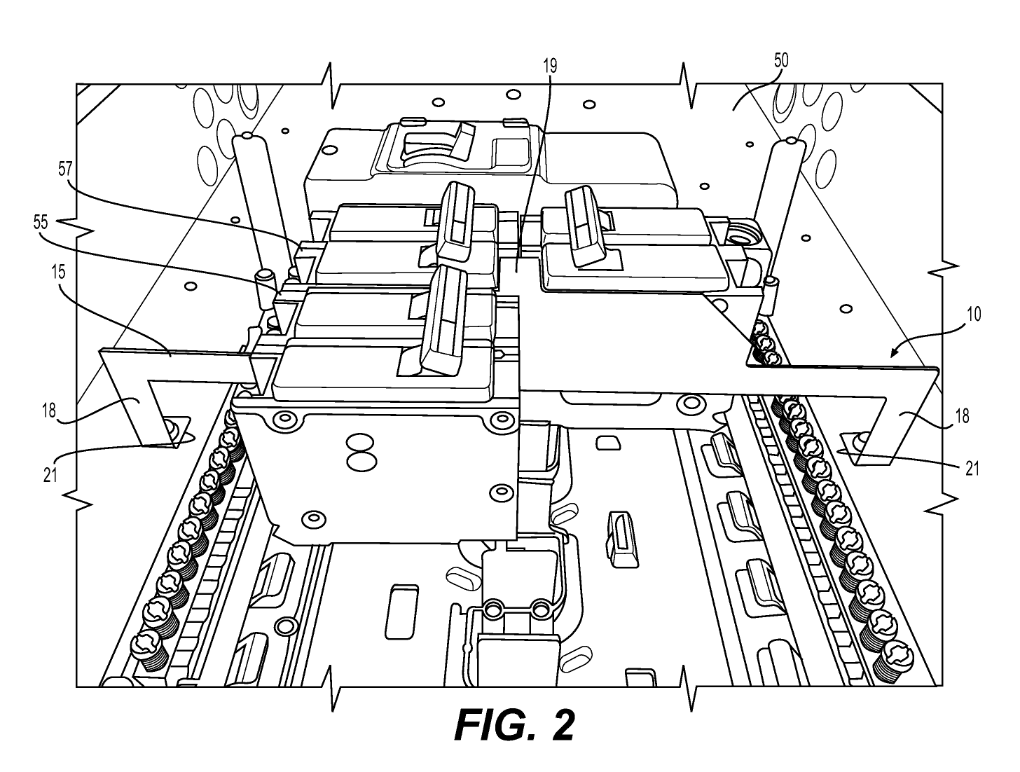

Referring to FIG. 1, the device 10 according to the invention includes a frame 15 and a pair of legs 18. The distance between the legs 18 should be sufficient to permit the device 10 to fit over the snap-in board or existing opening in the panel box. The device also includes a tab 19 that fits over the circuit breaker that it is desired that hold in place and to prevent the circuit breaker's accidental removal. Finally, the device includes feet 21 that can be screwed or otherwise affixed to the circuit breaker panel to prevent accidental removal. A notch 22 is cut partway through device 10 to allow for slight variation in the distance of the top of breaker 55 and panel 50 (shown in FIG. 2).

The parts of the device 10 can be formed of various metals or hard plastic materials having sufficient rigidity to restrain or hold the circuit breaker in place and prevent accidental removal. The legs 18 can be formed as separate pieces from the frame 15 or they can be integrally formed with the frame 15. For example, the legs 18 can be welded to the frame or they can be molded or cast as a single piece with the frame 15. Similarly, the feet 21 can be formed as separate pieces from the legs 18 and joined thereto, or the feet 21 can be integrally formed with the legs 18.

Referring to FIG. 2, the device 10 is installed in a circuit breaker box 50 between two adjacent circuit breakers 55, 57. The thinness of the frame 15 permits it to be fitted between the circuit breakers 55, 57, while its length permits the feet 21 to be attached to the circuit breaker box 50. The feet 21 are shown screwed into the circuit breaker box 50, although the feet 21 may be attached in other ways to prevent accidental removal of the device 10. Finally, restraining tab 19 is shown fitted over the top of circuit breaker 57 to restrain the breaker 57 in place. The feet 21 are shown with holes for the screws.

Various aspects and dimensions of the device 10 according to the present invention permit the device to be “universal” or capable of being used as a circuit breaker restraint in a large number of different circuit breaker boxes by various manufacturers. The thinness of the frame 15 permits the frame to fit between any adjacent circuit breakers 55, 57. The length of the frame 15 permits it to fit over any snap-in circuit breakers. The restraining tab 19 is configured to be able to restrain any type of snap-in circuit breaker.

In use, the user would attach the feet 21 to the circuit breaker box 50 by screws or similar attachments. The restraining tab 19 would keep the circuit breaker in place. When finished, the device 10 can be removed by removing the screws or other attachments from the circuit breaker box 50.

While the invention has been described in conjunction with specific exemplary implementations, it is evident to those skilled in the art that many alternatives, modifications, and variations will be apparent in light of the foregoing description. Accordingly, the invention is intended to embrace all such alternatives, modifications, and variations that fall within the scope and spirit of the appended claims.

What is claimed is:

1. A device for restraining a snap-in circuit breaker in a snap-in circuit breaker board, the device comprising:
a frame configured to fit between adjacent snap-in circuit breakers and having a length sufficient to span the snap-in circuit breaker board;
a restraining tab attached to or integrally formed with the frame such that, in use, the restraining tab is positioned over the snap-in circuit breaker to restrain the circuit breaker in place; and
a leg attached to or integrally formed with each end of the frame, the legs extending perpendicular to the frame; and
a foot attached to or integrally formed with each leg and configured to be attached to the snap-in circuit breaker board.

2. The device of claim 1, where in the device is formed of metal or plastic.

3. The device of claim 1, configured to fit within any circuit breaker board.
